(19) United States
(12) Patent Application Publication
(10) Pub. No.: US 2024/0081582 A1
(43) Pub. Date: Mar. 14, 2024

(54) A BEVERAGE PREPARATION VESSEL AND A METHOD OF PREPARING A BEVERAGE

(71) Applicant: TWO BROTHERS PTY LTD, Victoria (AU)

(72) Inventors: Christopher Farah, Victoria (AU); George Farah, Victoria (AU)

(21) Appl. No.: 18/557,120

(22) PCT Filed: May 2, 2022
(86) PCT No.: PCT/AU2022/050410

§ 371 Date: Oct. 25, 2023

(30) Foreign Application Priority Data
Apr. 30, 2021 (AU) 2021901288

(51) Int. Cl. A47J 41/00; A47J 41/02; B65D 21/02; B65D 81/38; B65D 85/72; G01F 19/00

(52) U.S. Cl. CPC A47J 41/0077; A47J 41/0038; A47J 41/0094; A47J 41/028; B65D 21/0233; B65D 81/38; B65D 85/72; G01F 19/00; A47J 2203/00

(57) ABSTRACT

The invention provides a beverage preparation vessel comprising: a base for supporting the vessel on a surface, a wall extending from the base and projecting upwardly therefrom to form a receptacle for receiving liquid, and a rim extending around an upper edge of the wall defining an opening to the receptacle and having a spout for pouring the liquid from the vessel, wherein the wall has a closed double-walled configuration comprising an inner wall and an outer wall being disposed in a spaced apart arrangement such that a gap is formed therebetween wherein the outer wall is thermally insulated from the inner wall and defines an external surface that can be gripped by a hand of a user, and the inner wall defines an internal surface that contacts the liquid in the receptacle and has measurement markings to enable the user to visibly measure the volume of liquid in the receptacle, and wherein the vessel has a profile that allows alike vessels to be stacked in a nested arrangement.

### FIELD OF THE INVENTION

The present invention relates to a beverage preparation vessel. Specifically, although by no means exclusively, the invention relates to a beverage preparation vessel for preparing hot beverages, such as coffee, tea, hot chocolate and the like. The invention also relates to a method of preparing a beverage using the beverage preparation vessel.

### BACKGROUND OF THE INVENTION

Takeaway hot beverages, such as coffee, are typically served in single use coffee cups. These coffee cups are intended to be disposed of in landfill after using only once. Unfortunately, single use coffee cups have long decomposition times and thus occupy a large proportion of landfill. Furthermore, single use coffee cups are one of the world's largest contributors to litter waste.

Reusable coffee cups have been touted as a solution to this problem. However, reusable coffee cups pose potential health and safety hazards to cafés. This is because reusable coffee cups must be handled by the barista during the preparation of the coffee and, if unclean, may transfer germs (i.e. bacteria and viruses) to the barista and/or the surfaces of the café. This compromises the health and safety of employees and customers of the café.

This issue has been particularly relevant during the COVID-19 pandemic, with many cafés banning the use of reusable coffee cups altogether.

It is desirable to provide a beverage preparation vessel and method that improves at least one of the above disadvantages or at least provides a useful alternative to known beverage preparation vessels and methods.

### SUMMARY OF THE DISCLOSURE

The present invention provides a beverage preparation vessel comprising: a base for supporting the vessel on a surface, a wall extending from the base and projecting upwardly therefrom to form a receptacle for receiving liquid, and a rim extending around an upper edge of the wall defining an opening to the receptacle and having a spout for pouring the liquid from the vessel, wherein the wall has a closed double-walled configuration comprising an inner wall and an outer wall being disposed in a spaced apart arrangement such that a gap is formed therebetween wherein the outer wall is thermally insulated from the inner wall and defines an external surface that can be gripped by a hand of a user, and the inner wall defines an internal surface that contacts the liquid in the receptacle and has measurement markings to enable the user to visibly measure the volume of liquid in the receptacle, and wherein the vessel has a profile that allows alike vessels to be stacked in a nested arrangement.

An advantage of the present invention is that a beverage can be prepared accurately within the vessel using the measurement markings and then poured out from the vessel into a second cup (e.g. a customer's reusable cup) without the need for the barista to handle the second cup.

One challenge of directly handling reusable cups from customers is that they are often unmarked and have different volumes. This makes it difficult to deliver the same volume of coffee to each cup which may impact on the taste of the coffee and profitability of the business.

The present beverage preparation vessel provides measurement markings which allow precise amounts of espresso, milk, water and froth to be dispensed into the vessel when preparing a range of different coffee beverages. This may boost the efficiency of the business.

The present beverage preparation vessel also allows contactless delivery of coffee to customers by enabling baristas to pour the prepared coffee into a customer's cup placed at a predetermined location by the customer without the barista having to handle the cup.

This minimises contact between the barista and the customer's cup to improve hygiene during the beverage preparation process.

A further advantage is that the insulting gap between the double walled structure of the vessel minimises heat transfer. This allows the vessel to be gripped without a risk of scalding the barista's hands. Therefore, the vessel removes the need for a handle to provide a more compact structure.

A handle-less design also facilitates the nesting of alike vessels in a compact arrangement to save space during storage. Furthermore, the handle-less design improves the aesthetics of the vessel.

The outer wall may extend from the periphery of the base.

The gap between the outer and inner walls may be filled with air or be placed under vacuum such that the outer wall is thermally insulated from the inner wall.

In some embodiments, the beverage preparation vessel includes an amount of reactive material to remove small amounts of contaminants or gas from the evacuated space between the inner and outer walls.

The reactive material may be selected from any one or more of the following: barium, aluminium, magnesium, calcium, sodium, strontium, caesium and phosphorus.

The reactive material may be known as a getter. The getter may be located on one of the opposing inner surfaces of the inner and outer walls.

The reactive material may be in the form of a coating. The reactive material may be applied to at least one of the opposing inner surfaces of the inner and outer walls to form a vacuum in the gap between the inner and outer walls.

The reactive material may be applied to any one or more of the inner wall, the outer wall, and the base.

In some embodiments, the measurement markings may be a series of recesses or grooves that are spaced apart along the internal surface in a direction along the longitudinal axis of the vessel. The ribs or grooves may extend around the internal surface to completely encircle the vessel, for example each rib or groove may form a ring shape around the vessel. Alternatively, the rib or groove may extend only partly around the internal surface. For example, the rib or groove may be in the form of a series of broken lines arranged end-to-end to encircle the vessel. It is desirable that any recess or groove in the internal surface is shallow enough to minimise the amount of beverage residue that may collect therein. Residue can be difficult to clean and is thus desirable to avoid. Alternatively, the measurement markings are in the form of a series of projections or ribs that are spaced apart along the internal surface in a direction along the longitudinal axis of the vessel. Each projection or rib measuring a liquid level that corresponds to a predetermined liquid volume.

In some embodiments, the rim defines a circular shaped profile. However, it is also envisaged that the rim may define an oval, rectangular, hexagonal, octagonal or any other polygonal profile.

In some embodiments, the rim comprises a surface that is inclined inwardly from the rim to the base so as to direct liquid into the receptacle. One advantage of this feature is that it prevents liquid from collecting on the rim and forming a residue.

In some embodiments, the rim surface extends linearly from the internal surface, i.e. flat, or may extend in a non-linear fashion, i.e. curved, from the internal surface.

At least one surface of the beverage preparation vessel may have surface modification including any one of a fine sandblasted finish, a brushed stainless steel finish, a polished finish and a coated finish. The surface may be textured, for example with protuberances, ribs or grooves. Suitably the surface is an exposed surface within the receptacle.

The surface may be any one of the rim surface, the internal surface of the receptacle and the external surface of the receptacle.

An advantage of having the mentioned surface modification is that it can reduce micro-foam retention.

In some embodiments, the base has a closed double-wall configuration comprising an inner base wall and an outer base wall disposed in a spaced apart arrangement such that a gap is formed therebetween.

The gap between the inner base wall and an outer base wall may be filled with air or be under vacuum such that the outer base wall is thermally insulated from the inner base wall.

In some embodiments, a heating element is incorporated into the base of the vessel. In such an arrangement, the heating element may be positioned within the gap between the inner and outer wall (as per the double-wall configuration) or underneath the base.

In some embodiments, the base has a single-wall configuration such that heat transfer through the base is effectively promoted. This is beneficial, for example, if a heating element is to be positioned underneath the base and used to heat the beverage within the vessel.

In some embodiments, the internal surface is inclined inwardly from the rim to the base so as to direct liquid away from the rim and into the receptacle. Having an inclined internal surface assists in providing a more gradual and controlled pour of liquids from the vessel. The internal surface may extend linearly from the base, i.e. to form a vertical wall, or may extend in a non-linear fashion, i.e. to form a curved wall. The internal surface may be smooth (e.g. polished).

In some embodiments, a fillet or chamfer is positioned at a junction between an inner surface of the base and the internal surface of the inner wall. This feature prevents liquid from collecting in the junction and drying to produce a residue.

In some embodiments, the wall and/or base is made from a thermally conductive material, suitably metal. More suitably the metal is stainless steel. Even more suitably, the stainless steel is AISI 304 stainless steel. Alternatively, the stainless steel may be AISI 316 stainless steel. However, it is also envisaged that other corrosion resistant metals may be suitable, for example: aluminium, titanium, gold, copper, bronze or brass. It is desirable that any material selected should be dishwasher safe up to 60° C.

In a preferred embodiment, the vessel comprises a two-piece construction comprising an inside piece and an outside piece.

Each of the inside and outside pieces may have a similar shape comprising a base and a wall extending from the periphery of the base and projecting upwardly therefrom to define a receptacle.

The inside and outside pieces may comprise a rim extending around an upper edge of the wall defining an opening of the receptacle and a spout projecting outwardly from the rim.

The spout may include an outwardly extending lip. Suitably, the lip is angled outwardly from the main body of the spout. This lip enables the formation of a narrow liquid stream when the beverage is being poured from the cup. This minimises spillage when the beverage is poured into the second cup, and facilitates the drawing of coffee art.

The spout may be formed integrally with the body of the vessel or formed separately and attached to the body of the vessel. There are different benefits of each type of spout. An integrally formed spout increases the structural integrity of the vessel while a separately formed spout allows the spout to be formed from a different type of metal to adjust the thermal conductivity of the spout.

The inside piece may be dimensioned such that it can be inserted into the outside piece in a nested arrangement. In this arrangement, a void is formed between the inside and outside pieces. Once in the nested arrangement, the rims of the inside and outside pieces can be secured together, for example by welding, adhering, fusing or otherwise. Once inside and outside pieces are joined together, the joint between the two pieces can be ground or polished, i.e. deburred, to improve the finish of the joint. Once assembled, the inside piece forms the inner wall and internal surface and the outside piece forms the outer wall and external surface.

Suitably, either or both the inside and outside pieces include a ledge. This may enhance of the structural integrity of the finished beverage preparation vessel by providing a surface to support the inside piece on the outside piece in a nested arrangement before the two pieces are joined together.

The ledge on the outside piece may improve pour performance by providing a surface for a user's hand, for example in the purlique of a user's hand, to rest and enhance grip.

In some embodiments, the outside piece may comprise a hole in the base such that air may be evacuated from the void to produce a vacuum. Once a vacuum has been produced, the hole may be sealed to maintain the vacuum. The hole may be sealed with melted glass. A cover plate may be secured to the underside of the base to cover the hole for aesthetic purposes. The cover plate may comprise branding, etched or otherwise, displayed thereon.

In some embodiments, both the inside piece and the outside piece may be produced by conventional metal drawing process. In this regard, the inside piece and outside piece may be produced by the same drawing tool or different drawing tools.

Suitably, the beverage preparation vessel is formed by a deep drawing process.

In some embodiments, the rim of the inside piece projects outwardly. The rim of the outside piece may project inwardly.

In some embodiments, the external surface has a recess for capturing liquid that drips down the external surface. This recess may enhance a user's grip on the beverage preparation vessel. This is particularly useful when pouring the contents from the beverage preparation vessel.

In some embodiments, the recess has a hemispherical shaped profile. It is also envisaged that the recess may have a conical or frustoconical shaped profile.

In some embodiments, the recess is a groove. The groove may extend around the external surface to completely encircle the vessel. For example, the groove may form a ring shape around the vessel. Alternatively, the groove may extend only partly around the external surface. For example, the groove may be a series of broken line grooves arranged end-to-end to encircle the vessel.

In some embodiments, the groove has a semi-circular shaped cross-sectional profile (i.e. U-shaped). It is also envisaged that the recess may have a triangular (i.e. V-shaped) or trapezoidal shaped cross-sectional profile.

In some embodiments, a portion of the external surface comprises a writable surface.

In some embodiments, the writable surface is configured such that it can be written on with chalk. In this regard, the writable surface may be formed by coating the external surface with chalkboard paint. Chalkboard paint is a specialized paint that creates a chalkboard like coating that can be utilized as a writing surface in the same manner as a traditional chalkboard or blackboard. Chalkboard paint is commonly made out of a mixture of talc, acrylic, water, glycol, titanium dioxide, carbon black, opacifiers, silica, and esters. It may also contain acetone, propane, butane, xylene, ethylbenzene, amorphous silica, n-butyl acetate, and propylene glycol methyl ether acetate which are industrial standard ingredients used in inks and paints as thinners, olfactory, and pigmentation agents.

In some embodiments, the writable surface is configured such that it can be written on by a non-permanent marker (e.g. whiteboard marker). In this regard, the writable surface may be formed by laminating the external surface with a polymer layer, such as a polypropylene film, or may be a sanded portion of the external surface. The polymer layer allows use of a non-permanent marker to write on the surface and be wiped clean from the surface.

The nested arrangement is defined by having at least 40% of the nesting vessel resting within the receiving vessel. More suitably, at least 75% of the nesting vessel rests within the receiving vessel. Even more suitably, the base of the nesting vessel abuts the base of the receiving vessel.

The present invention also provides a method of delivering a beverage to a cup without contacting the cup using the beverage preparation vessel as previously described, the method including the steps of: dispensing a measured amount of beverage into the vessel using the measurement markings; and delivering the beverage from the beverage preparation vessel via the spout into the cup.

An advantage of preparing a beverage according to this method is that the contact between the barista and the reusable cup is minimised. This reduces the risk of contamination and improves hygiene during the beverage preparation process.

In some embodiments, the method includes dispensing a plurality of different liquids that constitute the beverage when mixed together into the beverage preparation vessel. For example, espresso and hot water is dispensed sequentially to prepare a long black. Milk may be dispensed into the beverage preparation vessel to prepare café latte and cappuccino.

### BRIEF DESCRIPTION OF THE DRAWINGS

The present invention is described further by way of example with reference to the accompanying drawings of which:

FIG. 1 is a top perspective view of a beverage preparation vessel according to an embodiment of the present invention;

FIG. 2 is a bottom perspective view of the beverage preparation vessel shown in FIG. 1;

FIG. 3 is a schematic cross-sectional view of a wall of the beverage preparation vessel in FIG. 1;

FIG. 4 is a rendered side view of the beverage preparation vessel shown in FIG. 1;

FIG. 5 is a rendered top perspective view of the beverage preparation vessel shown in FIG. 1;

FIG. 6 is an exploded view of the vessel showing an inside piece and an outside piece that form part of the vessel shown in FIG. 1;

FIG. 7 is a top perspective view of the inside piece and the outside piece assembled to form the vessel shown in FIG. 1;

FIG. 8 is a bottom perspective view of the vessel shown in FIG. 7 and a cover plate;

FIG. 9 is a schematic top perspective view of a beverage preparation vessel according to a further embodiment of the present invention;

FIG. 10 is a schematic front view of the beverage preparation vessel shown in FIG. 9;

FIG. 11 is a schematic cross-sectional view of the beverage preparation vessel shown in FIG. 10 along the line A-A;

FIG. 12 is a schematic top view of the beverage preparation vessel shown in FIG. 9;

FIG. 13 is a schematic side view of two beverage preparation vessels, shown in FIGS. 9 to 12, in a stacked configuration;

FIG. 14 is a schematic cross-sectional view of the stack of beverage preparation vessels shown in FIG. 13 along the line B-B;

FIG. 15 is a schematic top perspective view of a beverage preparation vessel according to yet another embodiment of the present invention;

FIG. 16 is a schematic front view of the beverage preparation vessel shown in FIG. 15;

FIG. 17 is a schematic cross-sectional view of the beverage preparation vessel shown in FIG. 16 along the line C-C;

FIG. 18 is a schematic top view of the beverage preparation vessel shown in FIG. 15;

FIG. 19 is a schematic side view of two beverage preparation vessels, shown in FIGS. 15 to 18, in a stacked configuration;

FIG. 20 is a schematic cross-sectional view of the stack of beverage preparation vessels shown in FIG. 19 along the line D-D;

FIG. 21 is a top perspective view of a beverage preparation vessel according to another embodiment of the present invention;

FIG. 22 is a bottom perspective view of the beverage preparation vessel shown in FIG. 21;

FIG. 23 is a schematic perspective view of the beverage preparation vessel shown in FIG. 21;

FIG. 24 is a schematic side view of the beverage preparation vessel shown in FIG. 21;

FIG. 25 is a schematic front view of the beverage preparation vessel shown in FIG. 21;

FIG. 26 is a schematic top view of the beverage preparation vessel shown in FIG. 21;

FIG. 27 is a schematic cross-sectional view of the beverage preparation vessel shown in FIG. 25, along the line A-A;

FIG. 28 is a schematic bottom view of the beverage preparation vessel shown in FIG. 21;

FIG. 29 is a schematic cross-sectional view of two beverage preparation vessels, shown in FIGS. 21 to 28, in a stacked configuration;

FIG. 30 is a schematic enlarged view of the detail C in beverage preparation vessel shown in FIG. 29;

FIG. 31 is a perspective view of the beverage preparation vessel shown in FIG. 29;

FIG. 32 is a schematic perspective view of the beverage preparation vessel shown in FIGS. 21-31;

FIG. 33 is an enlarged view of the detail A circled in FIG. 32;

FIG. 34 is a rendered perspective view of the beverage preparation vessel shown in FIGS. 21-31;

FIG. 35 is an enlarged view of the detail B circled in FIG. 34;

FIG. 36 is a rendered perspective view of the beverage preparation vessel shown in FIGS. 21-31;

FIG. 37 is an enlarged view of the detail C circled in FIG. 36;

FIG. 38 is a rendered perspective view of the beverage preparation vessel shown in FIGS. 21-31;

FIG. 39 is an enlarged view of the detail D circled in in FIG. 38;

FIG. 40 is a schematic cross-sectional view of a spout and lip of the beverage preparation vessel shown in FIGS. 21-31; and

FIG. 41 is a flow chart of a method for making a beverage using a beverage preparation vessel according to an embodiment of the present invention.

### DETAILED DESCRIPTION OF SPECIFIC EMBODIMENTS

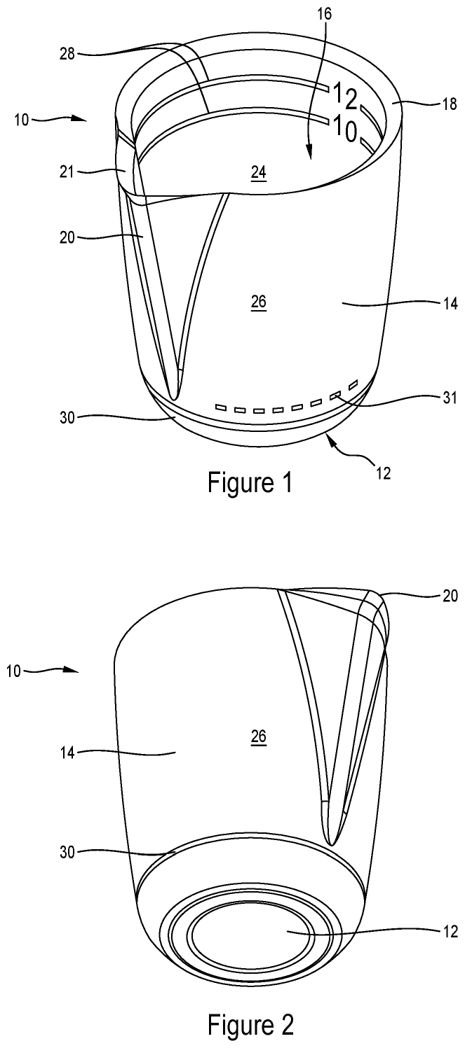

FIGS. 1 to 5 show a beverage preparation vessel according to an embodiment of the present invention.

Whilst the example below describes the preparation of coffee in a café by a barista, a skilled person can appreciate that the beverage preparation vessel can be used in other settings such as at home to prepare other types of beverages such as tea and hot chocolate.

A skilled person would also appreciate that whilst the examples in this specification are directed towards the preparation of hot beverages, the present beverage preparation vessel is equally adaptable to deliver cold beverages.

The beverage preparation vessel is in the form of a beaker-shaped cup 10 in which a beverage, such as hot coffee, can be prepared before it is poured into a second cup which is typically a reusable cup brought into a café by a customer. Preparing the coffee in this way minimises the contact between the barista and the reusable cup. This reduces the risk of contamination and improves hygiene during the beverage preparation process.

The cup 10 comprises a base 12 for supporting the vessel on a surface, such as a coffee bench, and a wall 14 extending from the periphery of the base 12 and projecting upwardly therefrom to define a receptacle 16 for receiving the liquid constituents of the beverage, e.g. espresso, hot water and frothed milk.

The cup 10 also includes a rim 18 extending around an upper edge of the wall 14 defining an opening of the receptacle 16. The rim 18 has a spout 20 that allows liquid to be poured cleanly from the cup 10. Spout 20 includes an outwardly extending lip 21 that is integrally formed with the rim 18.

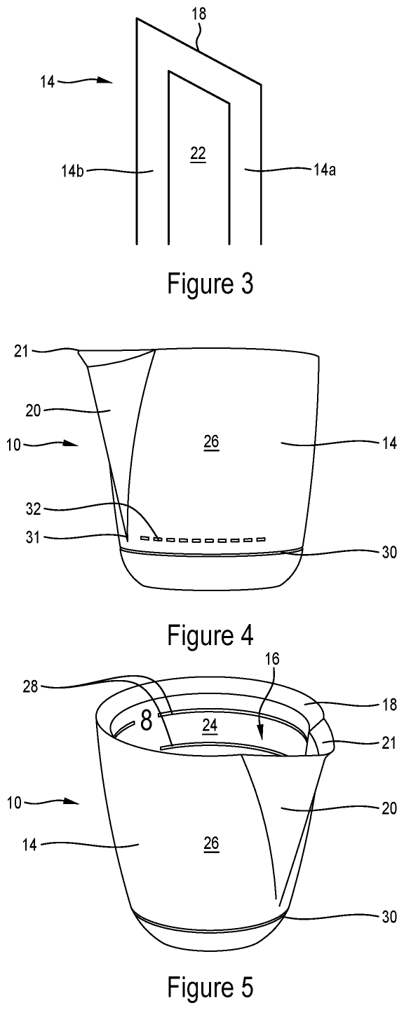

As shown in FIG. 3, the wall 14 has a closed double-wall configuration made from stainless steel 316 comprising an inner wall 14a and an outer wall 14b. The walls are disposed in a spaced apart arrangement such that a gap 22 is formed therebetween. The gap 22 is bounded by the rim 18 at an upper portion of the peripheral double wall 14. The rim 18 and spout 20 are also made from stainless steel 316. In this example, the spout 20 is integrally formed with the body of the cup 10.

The gap 22 is filled with air or has an at least partial vacuum present therein such that the outer wall 14b is thermally insulated from the inner wall 14a. It is preferable that the gap 22 is under vacuum to optimise insulation. However, filling the gap with air at atmospheric pressure would also be suitable.

The inner wall 14a defines an internal surface 24 of the receptacle 16 that contacts the liquid in the receptacle 16 and the outer wall 14b defines an external surface 26 that can be gripped by a hand of a user. The double-walled configuration, as previously described, thermally insulates the user's hand from the heat of the liquid. The double-walled configuration also assists in stabilising the temperature of the beverage in the vessel compared to a single-walled vessel. This feature negates the need for a handle. The internal surface 24 has measurement markings 28 to enable the user to visibly measure the volume of liquid dispensed into the receptacle 16.

The internal surface 24 has a fine sandblasted finish and the external surface has a brushed finish.

The cup 10 is shaped so that one cup 10 can be stacked within the receptacle 16 of another alike cup 10 in a nested arrangement. Specifically, the wall 14 extends outwardly from the base 12 to enable alike cups 10 to be stacked within each other such that at least 40% of the nesting vessel rests within the receiving vessel. This saves space and declutters the workspace.

As shown in FIG. 5, the rim 18 extends linearly between the internal and external surfaces 24, 26 and comprises a rim surface that is inclined inwardly from the opening of the cup 10 to the base 12 so as to direct liquid away from the rim 18 and into the receptacle 16.

Spout 20 comprises a lip 21 that improves pouring of the beverage into the customer's cup which minimises spillage. The lip 21 may also facilitate the drawing of precise coffee art by allowing the formation of a narrow beverage stream when poured from the cup 10.

Similarly, the internal surface 24 is inclined inwardly from the rim 18 to the base 12 so as to direct liquid away from the rim 18 and into the receptacle 16. A fillet is disposed at a junction between the internal surface 24 and an inner surface of the base 12 so as to avoid any sharp corners. This minimises areas in the receptacle in which residue may accumulate which can be difficult to clean.

As shown in FIGS. 1 and 2, the external surface 26 has a drip catching groove 30 that extends around the circumference of the cup 10 for capturing liquid that drips down the external surface 26. In other embodiments, the drip catching groove 30 extend part way along the circumference of the cup 10.

The cup 10 also includes a dashed line 31 located above the groove 30 and extends part way around the perimeter of the cup 10 to define the boundary of a writable surface 32 to allow a barista or cashier to mark the cup with information such as the type of drink to be prepared and the customer's name. The dashed line may be printed or etched onto the cup.

The writable surface has a polypropylene film that allows whiteboard markers to write on the surface and be wiped clean from the surface in a conventional manner to that of whiteboards. The writable surface may also be a sanded portion of the external surface.

A bottom surface of the base and a lower portion (located beneath the groove 30) of the external surface 26 may be powder coated in white pigment. However, it is also envisaged that these surfaces may be coated or painted any other colour as desired or dictated by branding. It is also envisaged that these surfaces may not be coated or painted, and the entire vessel may have the appearance of bare stainless steel.

As shown in FIG. 5, the internal surface 24 has a matt surface finish while the external surface 26 has a brushed finish to enhance grip.

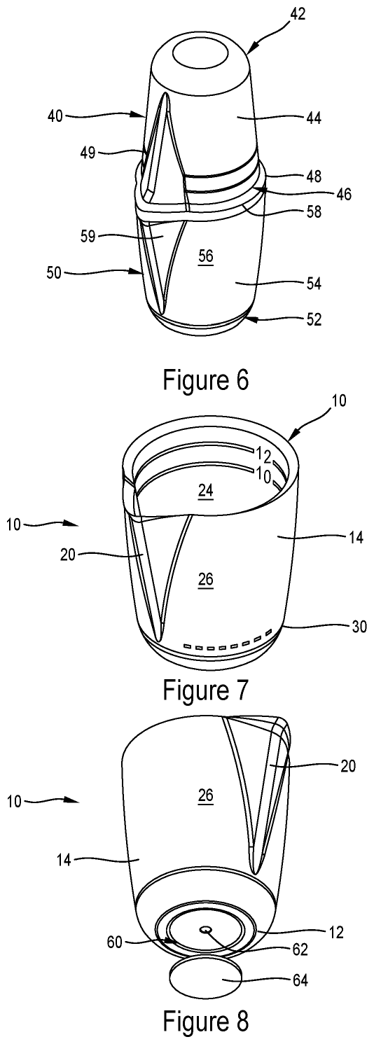

FIGS. 6 to 8 show three stages of the assembly process for producing the cup 10.

FIG. 6 shows an inverted inside piece 40 and an outside piece 50 that can be assembled together to form the cup 10.

The inside piece 40 has a base 42 and a wall 44 extending from the periphery of the base 42 and projecting upwardly therefrom to define a receptacle 46. The inside piece 40 also comprises a rim 48 extending around an upper edge of the wall 44 to form an opening of the receptacle 46 and a spout 49 projecting outwardly from the rim 48. The rim 48 has an outwardly projecting flange to direct liquid on the rim 48 into the receptacle 46.

The outside piece 50 has a base 52 and a wall 54 extending from the periphery of the base 52 and projecting upwardly therefrom to define a receptacle 56. The outside piece 50 also comprises a rim 58 extending around an upper edge of the wall 54 to form an opening of the receptacle 56 and a spout 59 projecting outwardly from the rim 58.

As can be seen in FIG. 6, the inside piece 40 has a plurality of preformed circumferential grooves on wall 44. These circumferential grooves form the measurement markings 28 when the inside and outside pieces 40, 50 are assembled to produce the cup 10.

The outside piece 50 has a preformed circumferential groove on the wall 54. This circumferential groove forms the drip catching groove 30 when the inside and outside pieces 40, 50 are assembled to produce the cup 10.

The inside piece 40 is dimensioned such that it can be inserted into the receptacle 56 of the outside piece 50 in a nested arrangement. In this arrangement, a void is formed between the inside and outside pieces 40, 50. Once in the nested arrangement, the rims 48, 58 of the inside and outside pieces 40, 50 are secured together, for example by welding the flange of the inside piece rim 48 to the outside piece rim 58. The spouts 49, 59 of the inside and outside pieces 40, 50 are welded together in similar fashion.

Once the inside and outside pieces 40, 50 are joined together, as shown in FIG. 7, the inside piece 40 defines the inner wall 14a (wall 44) and internal surface 24. Similarly, the outside piece 50 defines the outer wall 14b (wall 54) and external surface 26. The joint between the two pieces can be ground down, i.e. deburred, to improve the finish of the joint.

As shown in FIG. 8, the base 52 of the outside piece 50 comprises a rebate 60 with a centrally positioned hole 62. The hole 62 is configured such that air may be evacuated from the void to produce a vacuum. Once a vacuum has been produced, the hole 62 is sealed to maintain the vacuum. The hole can be sealed a number of ways including with melted glass. A cover plate 64 is dimensioned to fit inside the rebate 60 such that it is flush with an outer surface of the base 52. The cover plate 64 is secured to the underside of the base 52 to cover the hole 62 for aesthetic purposes. The cover plate 64 may comprise branding, etched or otherwise, displayed thereon.

The inside piece 40 and the outside piece 50 are produced by conventional metal drawing process using the same drawing tool.

The cup 10 can be produced in a range of different sizes.

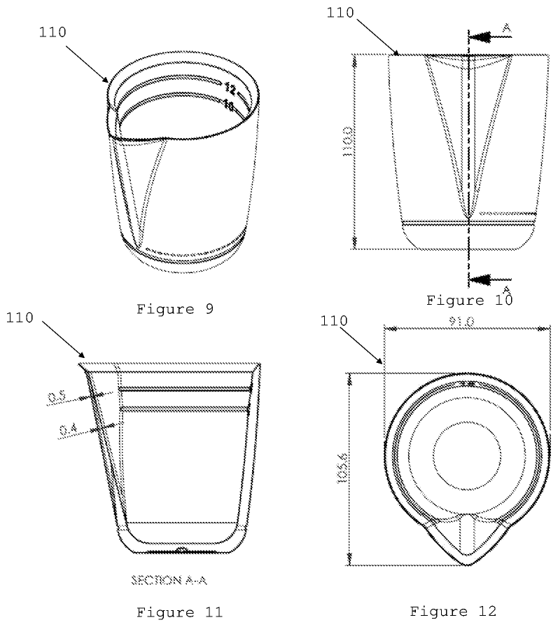

FIGS. 9 to 12 show an example of a ‘large’ 12 oz cup 110. The cup 110 comprises the same features as cup 10 but with the reference numbers starting with the prefix 1.

The overall height of the large cup 110 is from 108 mm to 115 mm. The width of the cup 110 is from 90 mm to 98 mm. The diameter of the opening of the receptacle is 91 mm. The spout projects from 10 mm to 25 mm from the rim of the cup 110. The internal depth of the receptacle is 95.0 mm. The two measurement markings are positioned at 63.5 mm and 74.5 mm from an inner surface of the base, respectively. Some embodiments may include three volumetric markings. For example, a 12 oz size cup can have 8 oz, 10 oz & 12 oz volume markers. The gap between the inner and outer walls is between 3.0 and 9.0 mm. The inner and outer walls have a thickness between 0.4 mm and 0.5 mm. The ‘large’ cup 110 is made from AISI 304 stainless steel and weighs approx. 218.5 g.

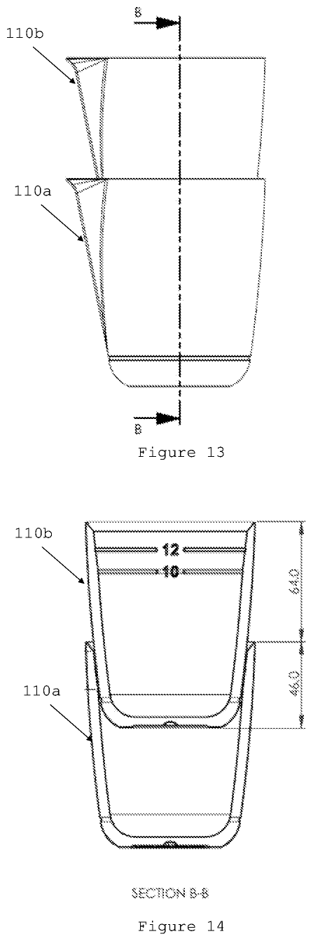

FIGS. 13 and 14 show two ‘large’ cups 110a, 110b stacked in a nested arrangement. In the nested arrangement, the cup 110b is inserted into the receptacle of the cup 110a by 46.0 mm such that a band of the internal surface of the receiving ‘large’ cup 110a contacts with a band of the external surface of the inserted ‘large’ cup 110b. The band having a depth of 20.1 mm. The applicant has found that this depth optimises the stability of two ‘large’ cups in the nested arrangement.

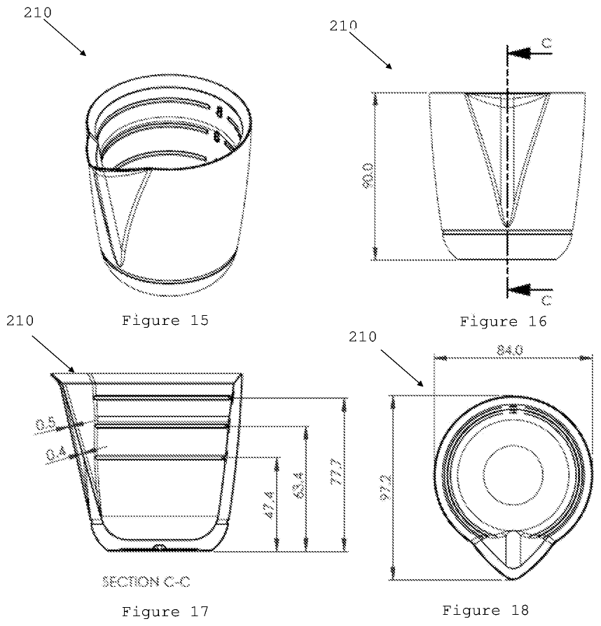

FIGS. 15 to 18 show an example of a ‘small’ 8 oz cup 210. The cup 210 comprises the same features as cup 10 but with the reference numbers starting with the prefix 2.

The overall height of the small cup 210 is from 88 mm to 95 mm. The width of the cup 210 is from 85 mm to 92 mm. The diameter of the opening of the receptacle is 84 mm. The spout projects from 8 mm to 20 mm from the rim of the cup 210. The three measurement markings (4 oz, 6 oz & 8 oz, respectively) are positioned at 47.4 mm, 63.4 mm and 77.7 mm from an inner surface of the base, respectively. The gap between the inner and outer walls is between 3.0 mm and 9.0 mm. The inner and outer walls have a thickness between 0.4 mm and 0.5 mm. The ‘small’ cup 210 is made from AISI 304 stainless steel and weighs between. 160 g and 175 g. Suitably, the cup weighs 166.4 g.

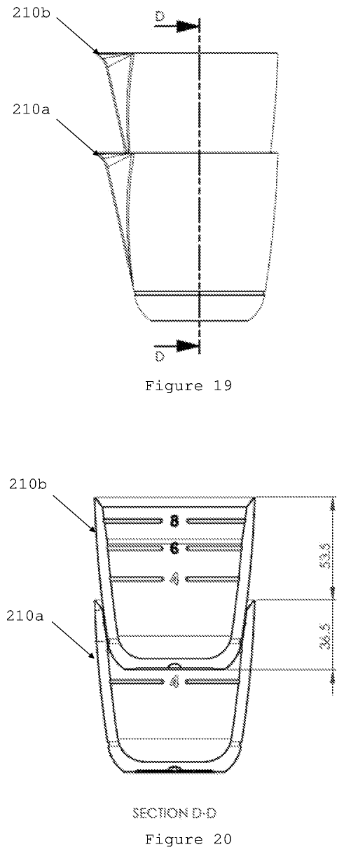

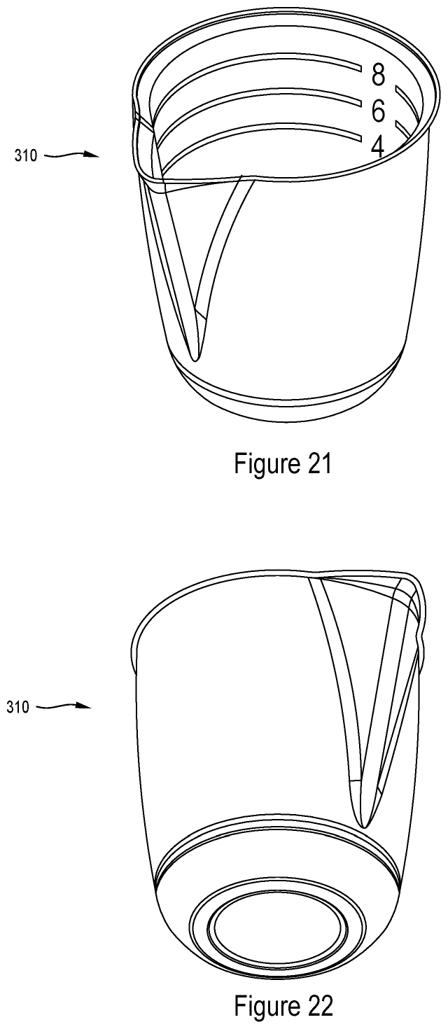

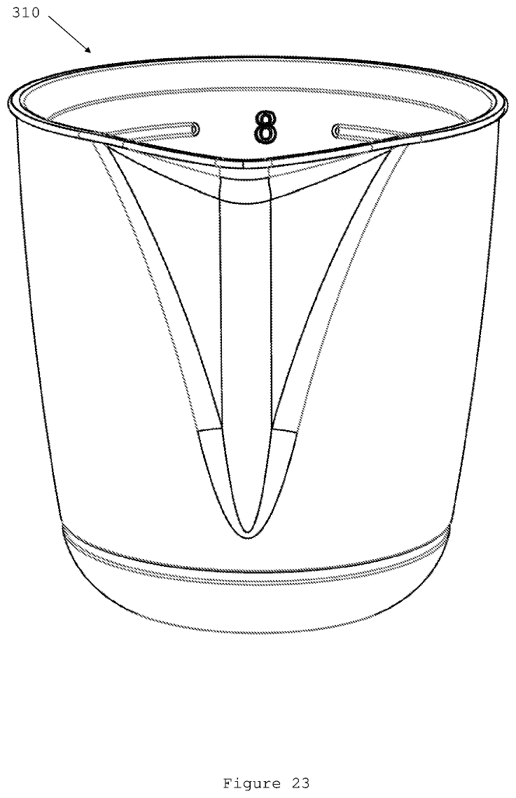

FIGS. 19 and 20 show two ‘small’ cups 210a, 210b stacked in a nested arrangement. In the nested arrangement, the cup 220b is inserted into the receptacle of the cup 220a by 36.5 mm such that a band of the internal surface of the receiving ‘small’ cup 210a contacts with a band of the external surface of the inserted ‘small’ cup 210b. The band having a depth of 16.5 mm. The applicant has found that this depth optimises the stability of two ‘small’ cups in the nested arrangement.

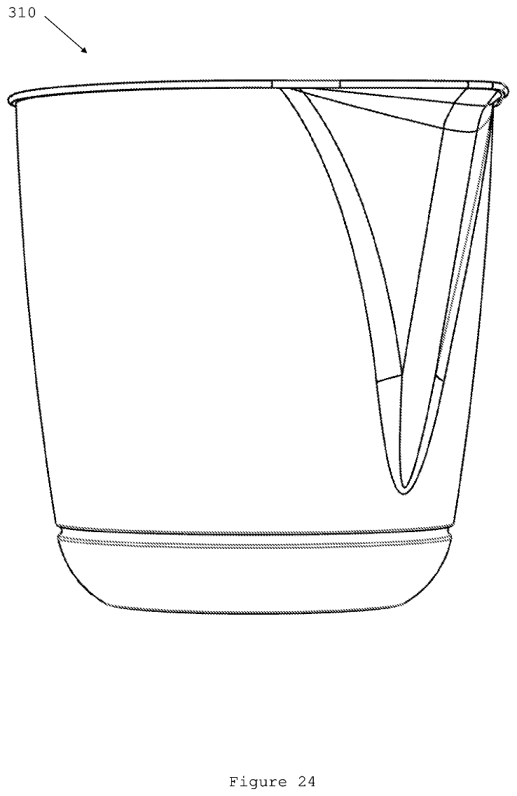

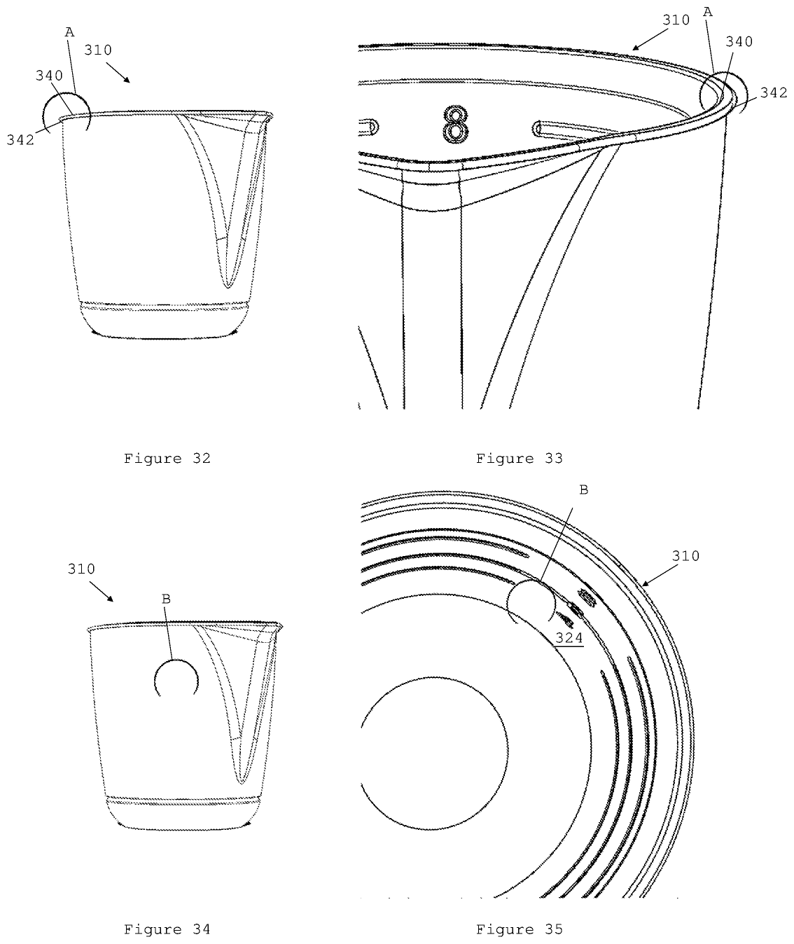

FIGS. 21-39 show a cup 310 according to another embodiment of the present invention. The cup 310 comprises the same features as cup 10 but with the reference numbers starting with the prefix 3.

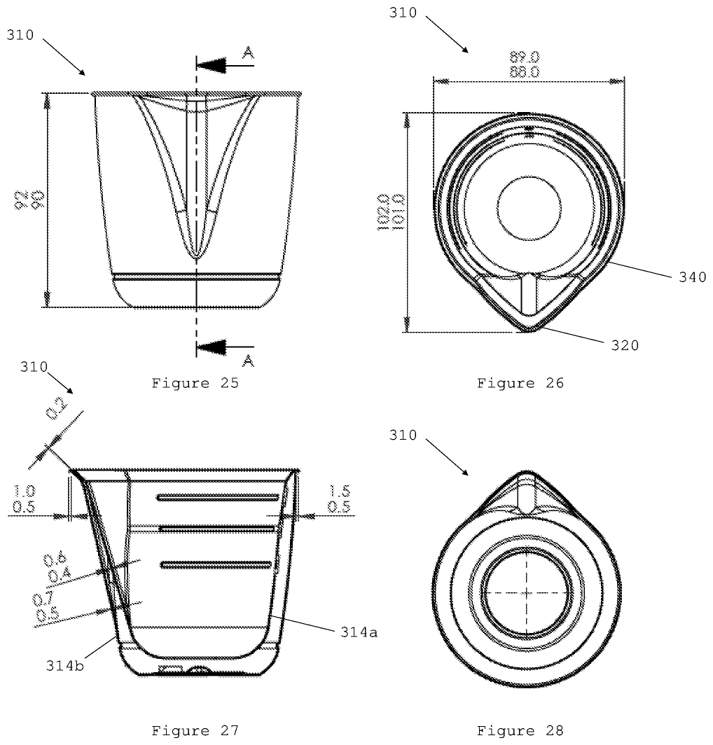

FIGS. 25-27 show the dimensions of the cup 310. The overall height of the cup 310 is between 90.0 mm and 92.0 mm. The diameter of the opening of the receptacle is between 87.0 mm and 89.0 mm. The spout 320 projects between 11 mm and 15 mm from the rim of the cup 310. The internal depth of the receptacle is 82.7 mm. The three measurement markings (8 oz, 10 oz & 12 oz, respectively) are positioned at 42.0 mm, 58.0 mm and 71.5 mm from an inner surface of the base, respectively. The gap between the inner and outer walls 314a, 314b is between 3.0 mm and 9.0 mm. The inner and outer walls 314a, 314b have a thickness between 0.4 mm and 0.7 mm. The cup 310 is made from AISI 304 stainless steel and weighs around 230 g. Suitably, the cup 310 weighs 226.8 g.

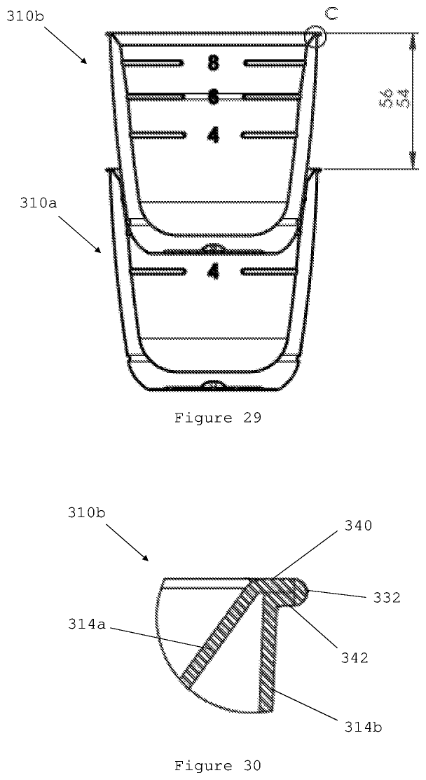

FIG. 29 show two cups 310a, 310b stacked in a nested arrangement. In the nested arrangement, the cup 320b is inserted into the receptacle of the cup 320a by between 34 mm and 38 mm such that a band of the internal surface of the receiving cup 310a contacts with a band of the external surface of the inserted cup 310b. The band having a depth of approximately 16.5 mm. The applicant has found that this depth optimises the stability of two cups in the nested arrangement.

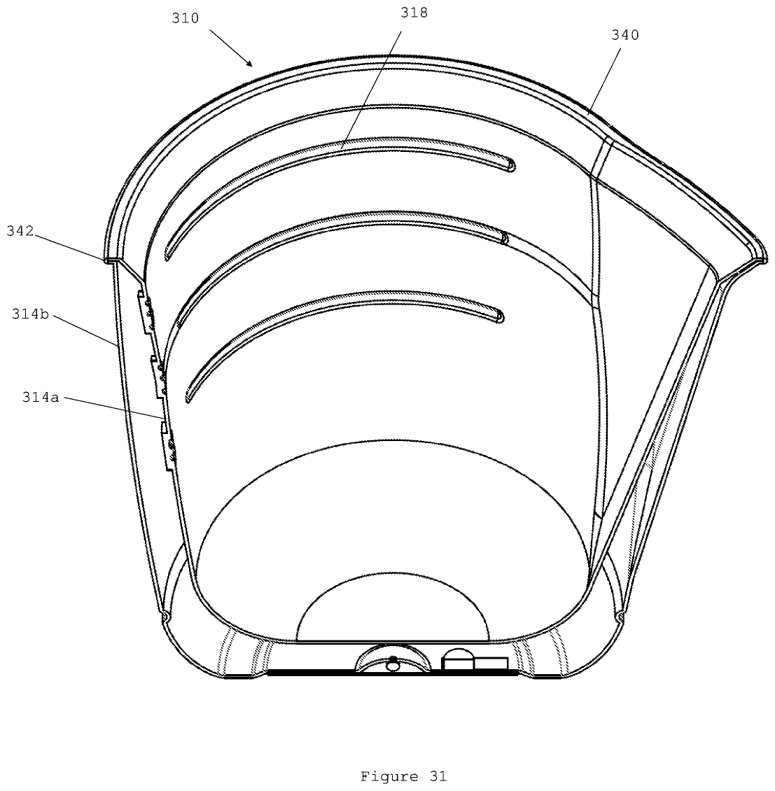

FIGS. 30-33 shows a cross-sectional profile of the rim of the cup 310. The rim comprises a pair of horizontal ledges 340 and 342 formed from the inside and outside pieces, respectively, which are fused together. The rim projects from the side wall 314 of the cup by 0.5 mm to 1.0 mm.

The cup 310 is formed by deep drawing. During the manufacturing process, the inside piece is profiled to form the measurement markings 318 and the outside piece is profiled to form the drip catching groove 330.

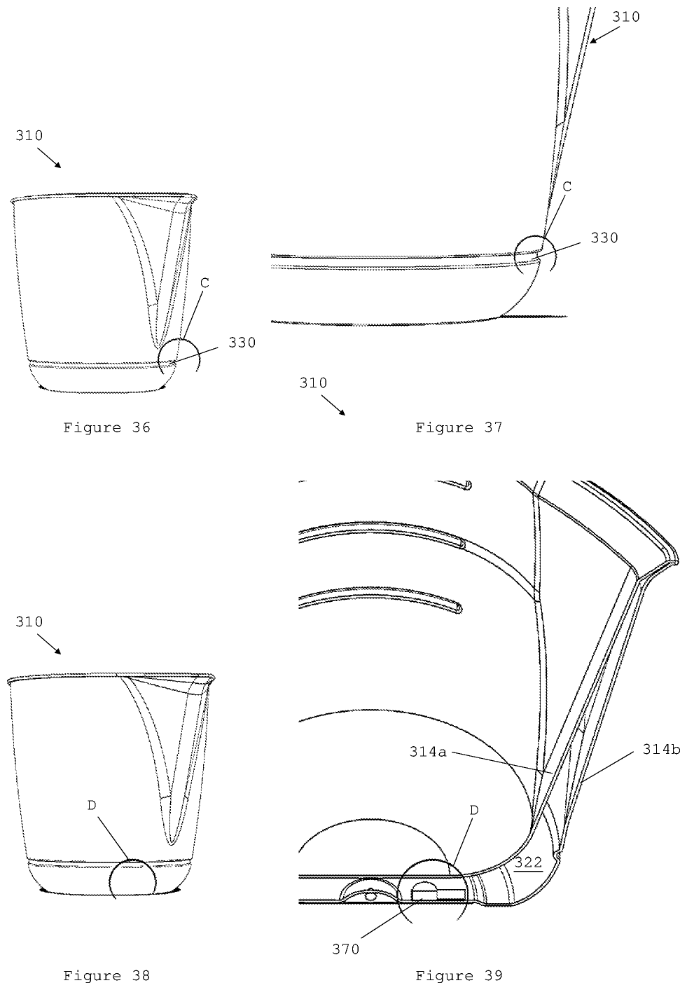

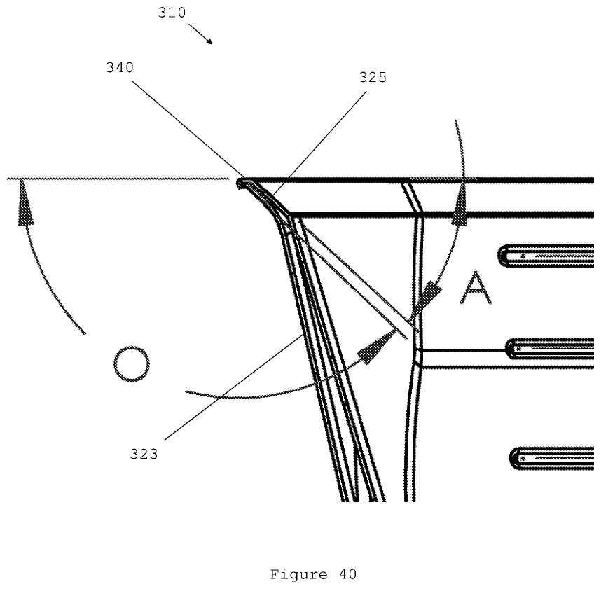

FIGS. 36 and 37 shows the drip catching groove 330. The drip catching groove 330 extends completely around the cup 310 and has a semi-circular cross-sectional profile, as best shown in FIG. 39. The applicant has found that the drip catching groove 330 may also enhance a user's grip of the cup 310. This is particularly useful when pouring the contents of the cup 310.

In some embodiments, the profiling can be performed after the cup 310 is formed.

The surfaces of the inside and outside pieces are then finished to provide a textured surface.

FIG. 35 show a textured area of the internal surface 324 of the cup 310 for reducing microfoam retention on the internal surface 324 of the cup 310 formed by coffee and/or milk. The textured internal surface may be a fine sandblasted finish, a brushed stainless-steel finish, a polished finish or a coated finish. The textured internal surface may comprise an array of protuberances that project from the internal surface 324. Each protuberance projects between 1 μm and 2 mm from the internal surface 324 and is distanced from an adjacent protuberance by between 1 mm and 10 mm.

As shown in FIGS. 38 and 39, an amount of reactive material (a getter 370) is located between the opposing surfaces of the inside and outside pieces within the gap 322. Preferably the getter 370 is attached to one or more of the opposing surfaces. The getter 370 facilitates removal of small amounts of gas from the gap 322 between the inner and outer walls 314a, 314b. The reactive material can be any one or more of barium, aluminium, magnesium, calcium, sodium, strontium, caesium and phosphorus.

The ledge 340 is formed by folding the upper edge of the inside piece clockwise at an angle of between 100° and 150° to form a horizontal surface and the ledge 342 is formed by folding the outside piece clockwise at an angle of between 80° and 100° to form a similar horizontal surface.

The two ledges are then aligned such that ledge 340 of the inside piece is supported on the corresponding ledge 319 of the outside piece in a nested configuration. The edges of the two ledges are then welded together at their edges to form a welded joint 332. The method may include deburring and/or polishing the welded joint.

After the cup 310 is formed, air is evacuated from the gap between the inner and outer walls 314a, 314b to form the finished product. The getter 370 enhances the vacuum in the gap by removing small amounts of gas from the gap 322 between the inner and outer walls 314a, 314b.

FIG. 40 shows the spout 320 and lip 321 of the cup 310. The wall of the spout 320 is angled relative to the ledge 340 and is divided into a first portion 323 and a second portion 325. The first portion 323 comprises majority of the wall of the spout 320. The second portion 325 extends between the first portion 323 and the ledge 340. The internal surface of the second portion 325 is angled relative to the spout at an acute angle A. The external surface of the second portion is angled relative to the spout at an obtuse angle O. The applicant has found that the acute angle A improves pour performance by breaking the surface tension (and capillary forces) of the liquid at the transition between the second portion 325 and the ledge 340. This allows the cup to pour cleanly when filled up to the top marker and minimises dribbling compared to milk pitchers or water jugs.

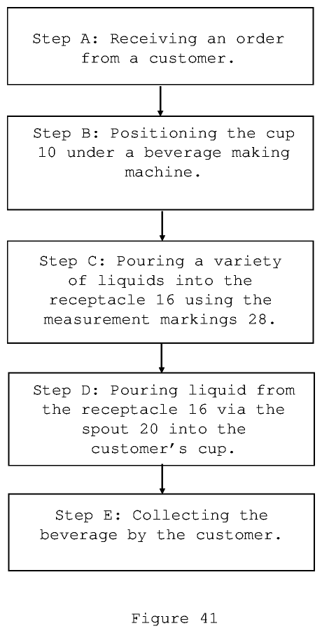

FIG. 41 shows a flow chart for a method of preparing a beverage using the beverage preparation vessel according to an embodiment of the present invention.

The method includes the following steps:
Step A: Receiving an order from a customer. Ideally this involves contactless payment using an EFTPOS machine. The order is then written onto a cup 10 which is passed to the barista.
Step B: Positioning the cup 10 under a beverage making machine, for example an espresso machine.
Step C: Pouring a variety of liquids that constitute the beverage into the receptacle 16 until each liquid reaches its desired liquid level using the measurement markings 28.

For example, when making a single cup of cappuccino, one shot of espresso is dispensed into the cup 10 before a measure of milk is added to the espresso.

When making a long black, the espresso machine dispenses a shot of espresso before a measure of hot water is added to the espresso. The volume of different liquids (e.g. espresso, water and milk) can be carefully moderated by the barista using the measurement markings 28.
Step D: Transferring the beverage from the receptacle 16 via the spout 20 into a customer's cup which is placed by the customer at a predetermined location identified by the barista. The double-wall configuration of the wall 14 prevents the barista from burning his or her hand while performing this task. This step can be achieved without the barista touching the cup.

The spout 20 allows the frothed milk to be accurately poured into the cup to produce coffee art.
Step E: Collecting the beverage by the customer. Once the beverage has been poured into the cup, the customer can collect the cup to complete the transaction.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1-13. (canceled)

14. A beverage preparation vessel comprising: a base for supporting the vessel on a surface, a wall extending from the base and projecting upwardly therefrom to form a receptacle for receiving liquid, and a rim extending around an upper edge of the wall defining an opening to the receptacle and having a spout for pouring the liquid from the vessel, wherein the wall has a closed double-walled configuration comprising an inner wall and an outer wall being disposed in a spaced apart arrangement such that a gap is formed therebetween wherein the gap extends from the base to the rim and the gap between the inner and outer wall is under vacuum such that the outer wall is thermally insulated from the inner wall and defines an external surface that can be gripped by a hand of a user, and the inner wall defines an internal surface that contacts the liquid in the receptacle and has measurement markings to enable the user to visibly measure the volume of liquid in the receptacle, and wherein the vessel has a profile that allows alike vessels to be stacked in a nested arrangement.

15. The beverage preparation vessel of claim 14, wherein the base is a closed double-wall configuration comprising an inner wall and an outer wall and being disposed in a spaced apart arrangement such that a gap is formed therebetween, such that the outer wall is thermally insulated from the inner wall.

16. The beverage preparation vessel of claim 14, wherein the rim comprises an inwardly inclined surface that directs liquid into the receptacle.

17. The beverage preparation vessel of claim 14, wherein the internal surface is inclined inwardly from the rim to the base so as to direct liquid into the receptacle.

18. The beverage preparation vessel of claim 14, wherein the wall is constructed from metal.

19. The beverage preparation vessel of claim 18, wherein the metal is stainless steel.

20. The beverage preparation vessel of claim 14, wherein the external surface has a recess for capturing liquid that drips down the external surface.

21. The beverage preparation vessel of claim 14, wherein a portion of the external surface comprises a writable surface.

22. The beverage preparation vessel of claim 14, wherein a reactive material is applied to at least one of the opposing inner surfaces of the inner and outer walls to form a vacuum in the gap between the inner and outer walls.

23. The beverage preparation vessel of claim 14, including a heating element in the base of the vessel.

24. The beverage preparation vessel of claim 14, including a fillet or chamfer positioned at a junction between an inner surface of the base and the internal surface of the inner wall.

25. The beverage preparation vessel of claim 14, comprising a two-piece construction comprising an inside piece and an outside piece.

26. The beverage preparation vessel of claim 25, wherein either or both the inside and outside pieces include a ledge.

27. A method of delivering a beverage to a cup without contacting the cup using the beverage preparation vessel of claim 14, the method including the steps of: dispensing a measured amount of beverage into the vessel using the measurement markings; and delivering the beverage from the vessel via the spout into the cup.

28. The method of claim 27, including dispensing a plurality of different liquids that constitute the beverage using the measurement markings on the vessel.

29. The method of claim 27, including stacking alike vessels in a compact arrangement prior to the dispensing step.
